(19) United States
(12) Patent Application Publication
(10) Pub. No.: US 2006/0242274 A1
(43) Pub. Date: Oct. 26, 2006

(54) Protecting system for data used by java applications

(75) Inventors: Petri Pirhonen, Helsinki (FI); Lauri Piikivi, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/452,749

(22) Filed: Jun. 13, 2006

Related U.S. Application Data
(63) Continuation of application No. PCT/FI04/00746, filed on Dec. 8, 2004.

(30) Foreign Application Priority Data
Dec. 17, 2003 (FI) 20031843

(51) Int. Cl. G06F 15/177

(52) U.S. Cl. 709/220

(57) ABSTRACT

The invention relates to a method for protecting data used by Java applications and a device using the method. The writer of a Java application adds to its attribute table an attribute signifying the need to protect the data used by the application. When the application is loaded into the user's device, the table with its attributes is also loaded. The operating system of the device has an extension related to the Java storage engine, which implements the data protection if the storage engine has found a protection attribute during the storing of data. The implementation of the protection can be based e.g. on encryption or on inhibiting access to a certain memory range from all other programs than the Java application in question. The access of a user of a Java application to data which are intended to be kept protected is made remarkably more difficult. The protection is implemented without changing the standardized interfaces of the Java platform.

### BACKGROUND OF THE INVENTION

Java is a C++ type object-based programming language. It has a wide usability, because a Java platform can be installed in a great variety of different applicable devices. The platform is composed of software means by which a Java application is adapted to the host device. These means include a so-called virtual machine, which converts programs written in Java, or Java code into the machine language of the host device and offers host device services in the Java language to the Java application. In addition, the platform includes other adaptation programs between the Java application and the device operating system.

FIG. 1 is a simplified layer diagram depicting the linking of a Java application with the device. In this example the device is a mobile station. The Java application 130 is uppermost in the diagram. Between it and the operating system 110 of the device there is a Java platform 120, which is in this example the J2ME (Java2 Micro Edition). In the platform there is the above mentioned virtual machine, and as other adaptation programs CLDC (Connected Limited Device Configuration) and MIDP (Mobile Information Device Profile). The adaptation programs and the Java application can have many software interfaces of different types, which are called API (Application Programming Interface). Through these interfaces the Java application is thus connected to its platform and the host device. For this purpose, all the platforms including MIDP have at least so-called RMS-API (Record Management System). In order that the Java application could use the device memory, which retains its content even if there is no operating voltage, a dedicated program is needed for it, and in this description it is called a storage engine. The storage engine 125 consists partly of programs of the Java platform and partly of programs of the operating system of the device. In the example of FIG. 1, the Java application uses the storage engine through the above mentioned RMS-API. If not otherwise stated, the term “memory” means in this description and the claims a non-volatile memory of the type mentioned above. The most common memory of this type is the so-called flash memory.

In the host device's own application programs there may be some programs that can be utilized in the Java application. In FIG. 1, programs like this are marked as OEM applications (Original Equipment Manufacturer). Furthermore, the function programs FP proper of the device is drawn in FIG. 1, and the physical part of the device including the memory 101 as a separate block.

FIG. 2 shows an example of a known manner to store data used by a Java application in the device memory, which retains its contents even if the operating voltage were switched off. The Java applications are here called MIDlet, in which MID refers to the MID profile on the J2ME platform. FIG. 2 is a flow chart, at the beginning step of which a MIDlet has been loaded into the host device and it is started. In connection with the loading, the so-called attributes of the MIDlet have also been loaded into a table reserved for them. The attributes are pieces of information of a parametric nature required by the execution of a MIDlet, such as the required amount of memory and the APIs used by the MIDlet. In step 201, the MIDlet program is executed. When data is to be stored into the memory during the execution of the program (step 202), the MIDlet gives to the RMS-API a notice of a predefined form, in which notice the address information of the data to be stored is included (step 203). The storage engine receives the notice, and its different parts prepare the transfer of data. In step 204, the storage engine writes the data into the memory. In step 205, the storage engine informs the MIDlet via the API that the storing has taken place, and if this does not succeed for some reason, that the storing has failed. After this, the execution of the program continues.

FIG. 2 shows only the storing into the memory. Reading from the memory takes place in a corresponding manner, being started by a request given by a MIDlet to the storage engine, the target data being appeared from the request.

The method described above has the drawback that the data stored in the memory by a Java application can also be read by means of suitable auxiliary programs, for example in the C++ language. Even information intended to be kept secret will not remain secret then. The user can, for example, discover the license information of a commercial application and distribute it among his acquaintances, for example. They can then save the information into their own machines and use the application free of charge. The user can also change a numerical value possibly existing in the stored data and concerning him into a direction which is more advantageous for him. The protection of data as such can naturally be implemented in the known ways, but the standardized API interfaces do not enable giving a notice of the need for protection.

### SUMMARY OF THE INVENTION

The object of the invention is to reduce the above mentioned drawback of the prior art. The protection method according to the invention is characterized in what is set forth in the independent claim 1. The device according to the invention is characterized in what is set forth in the independent claim 8. Some preferred embodiments of the invention are set forth in the other claims.

The basic idea of the invention is the following: The writer of a Java application adds to its attribute table an attribute signifying the need to protect the data used by the application, i.e. a protection attribute. The operating system of the device includes an extension related to the Java storage engine for the data protection. When the data is being stored, the storage engine checks if there is a protection attribute in the attribute table. If there is, the storage engine asks for the data protection. This can be based e.g. on encryption or on inhibiting access to a certain memory range from all other programs than the MIDlet in question.

The invention has the advantage that it is made remarkably more difficult for a user of a Java application to acquire information which is intended to be kept protected. From the point of view of a seller of a commercial application, the advantage is that possibilities for using the application free of charge are reduced. In addition, the invention has the advantage that the protection is implemented without changing the standardized interfaces of the Java platform, i.e. it is not necessary to modify the standard.

### BRIEF DESCRIPTION OF THE DRAWINGS

In the following, the invention will be described in more detail. Reference will be made to the accompanying drawings, in which

FIG. 1 shows a layer diagram of the linking of a Java application with the device,

FIG. 2 shows as a flow chart an exemplary prior art way of storing data used by a Java application into the memory of a device,

FIG. 3 shows as a layer diagram an exemplary linking of a Java application with the device according to the invention,

FIG. 4 shows as a flow chart an exemplary way of storing data used by a Java application into the memory of a device according to the invention,

FIGS. 5a, b show the method according to FIG. 4 in more detail with regard to data protection,

FIG. 6 shows an example of a device according to the invention.

### DETAILED DESCRIPTION OF THE INVENTION

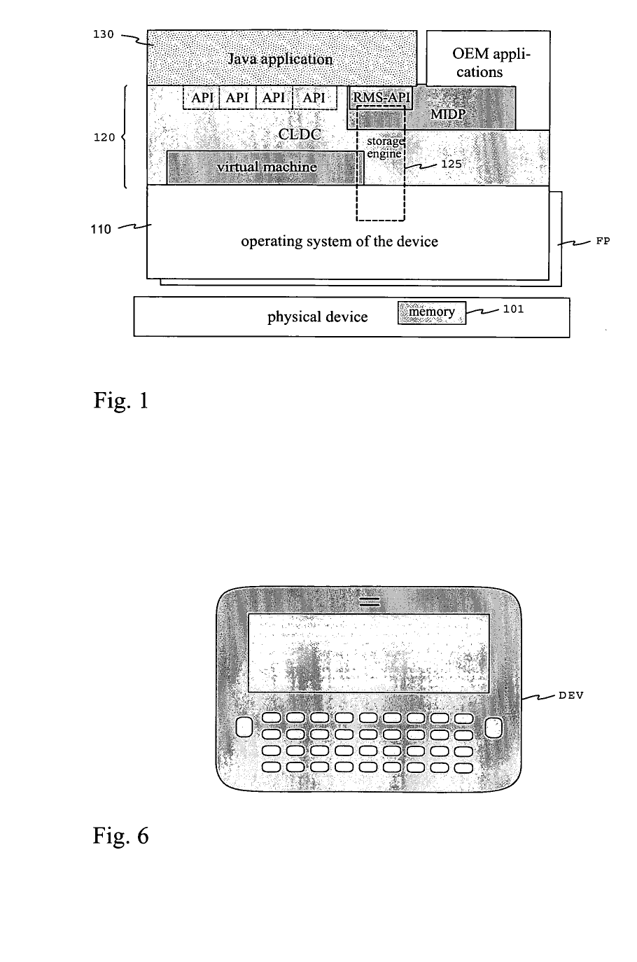

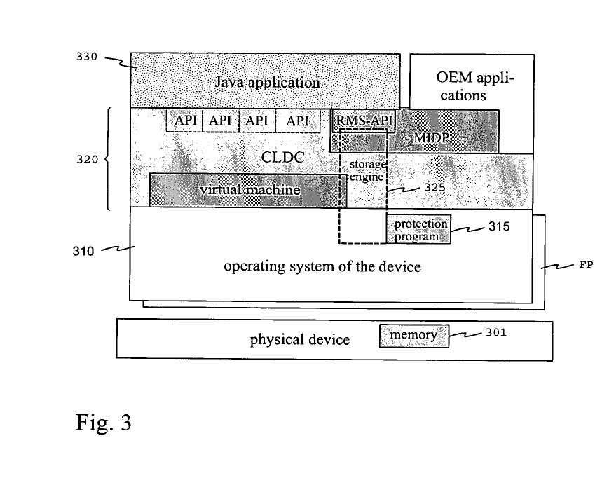

FIG. 3 shows as a layer diagram an example of a linking of a Java application with the device according to the invention. The figure shows, among other things: The Java application 330, the Java platform 320, the operating system 310 of the device, the storage engine 325 and the memory like in FIG. 1. The difference as compared to the diagram in FIG. 1 is the fact that the operating system of the device now includes as an extension a protection program 315 connected to the storage engine. The protection program implements the protection of data to be stored in the memory, for which purpose it has a data-specific secret code, for example.

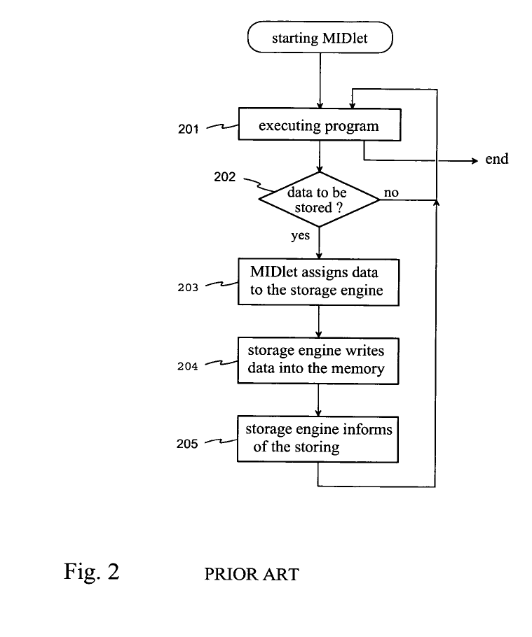

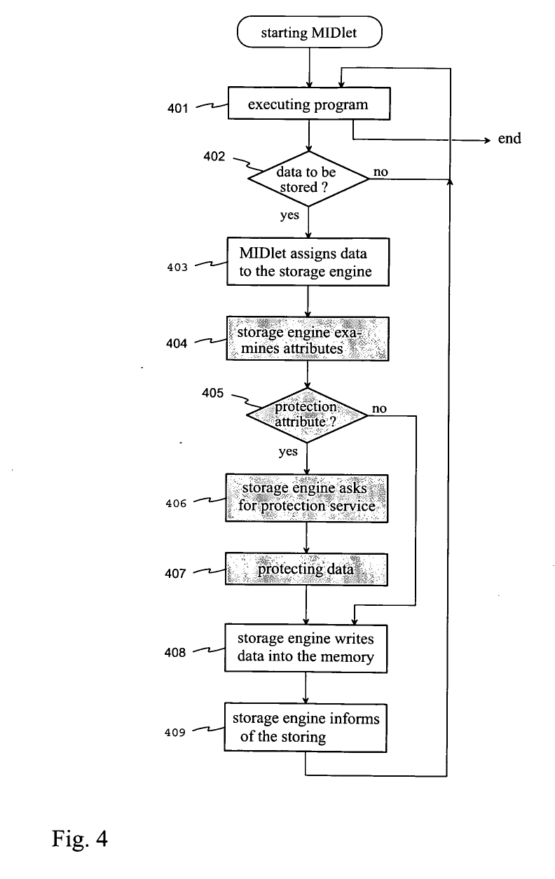

FIG. 4 shows a flow chart of an exemplary way according to the invention of storing data used by a Java application into the memory of a device. The first part of the chart is similar as in FIG. 2: In step 401, a MIDlet has been started and its program is being executed. When data is to be stored into the memory during the execution of the program (step 402), the MIDlet gives a notice of a predefined form to the API being used, in which notice the address information of the data to be stored is included (step 403). The data is then in the RAM (random access memory) type memory of the device. The storage engine receives the notice, and its different parts prepare the transfer of data. Steps 404, 405, 406 and 407 represent operation according to the invention. In step 404, the storage engine enquires the appropriate part of the Java platform the contents of the attribute table. The part of the Java platform in question is, depending on the case, the security manager or the application manager, for example. In step 405 the storage engine checks from the reply it received whether the data in question must be protected. If it must, the storage engine asks for protection service, or gives the protection program a data protection request, step 406. In step 407, the protection program carries out the protection corresponding to the request, using here a secret code which cannot be used by any other program. The secret code can be e.g. an encryption key or a data-specific identifier, which is used as a key for accessing a certain memory range. In step 408, the storage engine writes the data into a non-volatile memory, and in step 409 it reports the end result of this process to the MIDlet via API. The result is either that data has been stored as protected, or the storing has failed for some reason. After this, the execution of the program continues. If it is found out in step 405 that no protection attribute is associated with the data, the operation continues directly from step 408.

Above the information of the need for data protection is received to the storage engine by means of a program managing the attribute table without using any API interface for the data transfer. In fact, they cannot even be used for the purpose, because the interface is standardized, and no operations related to data protection have been defined in the standard. If some API standard is changed for this part in the future, it will then be a different matter.

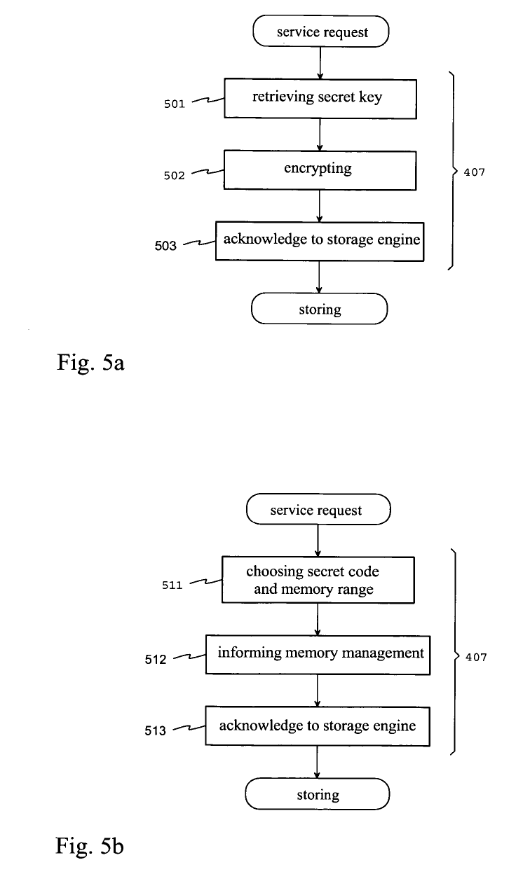

FIG. 5a shows an example of data protection as a flow chart, i.e. of the contents of step 407 in FIG. 4. In this example, the protection of data is based on its encryption. The protection operation starts from a service request given by the storage engine, including the RAM address of the data and an identifier selected for it by the storage engine. In step 501, the protection program retrieves or generates a secret key. This can be, for example, a number calculated from the program code of the MIDlet in a certain manner, or a secret code permanently resident in the host device. When the device is a mobile station, such a secret code is a subscriber-specific number hidden in the mobile station and used in authenticating the terminal in mobile communications. The secret key can also be generated by using a password selected by the user as one operand, which is asked and checked by the device each time the operation is started. In step 502 the protection program encrypts the data to be stored according to a certain algorithm and using the secret key. In step 503 the protection program acknowledges the service request by informing the storage engine that the encryption is complete. For decryption to be carried out later, the protection program stores the identifier of the data in question into its own file together with the key used in the protection. The storage engine for its part stores the encrypted data after receiving the acknowledgement.

When the MIDlet is reading the data stored as protected, it gives the storage engine a request indicating the target data. On the basis of the request, the storage engine first retrieves the data from the non-volatile memory to the RAM and then asks the protection program to decrypt the encrypted data in question. When this has taken place, the storage engine reports the data to the MIDlet via the API.

FIG. 5b shows another example of data protection as a flow chart. In this example, the data protection is based on inhibiting access to the memory space reserved for the data from all other programs than the MIDlet that “owns” the data. In step 511 the protection program selects a case-specific secret code. This can be, for example, the same as the identifier selected for the data by the storage engine. In addition, the protection program selects the memory range to which the data will be stored. In step 512 the protection program informs the memory management of the host device of the memory range and the secret code related to it. In step 513 the protection program acknowledges the service request by informing the storage engine that the protection is complete. The storage engine for its part stores the data after receiving the acknowledgement.

If, after the procedure described above, a program of the C++ language, for example, loaded into the device addresses a reading instruction to the memory range in question, the memory management prevents the execution of the instruction. Instead of that, when the MIDlet that “owns” the data in question reads the data, the storage engine asks the protection program to remove the protection made for the data in question. The protection program transmits the request to the memory management, which removes the reading denial temporarily. The denial is returned when the storage engine has read the data.

FIG. 6 shows an example of a device according to the invention. The device DEV can be a mobile station or a portable computer, for example. It is equipped with a memory and software including a Java platform and an operating system. Certain parts of these form a storage engine, which is arranged to store into the memory and to read from the memory data used by a Java application loaded into the device. Between the Java platform and the Java application there is at least one specified interface, through which the control information needed for storing and reading the data is transferred. As an extension of the operating system, there is also a protection program, which implements the protection of the data to be stored when the storage engine asks for the protection.

Examples of a method and device according to the invention have been described above. In its details, the implementation of the invention can naturally differ from that presented. For example, the storage engine and the protection program can be so organically combined that the latter can be regarded as belonging to the former. The inventive idea can be applied in different ways within the scope defined by the independent claims 1 and 8.

1. A method for protecting data of a Java application to be stored into a memory of a device, the software of which device comprises a Java platform having at least one specified interface towards the application, and an operating system, certain parts of which together with certain parts of the Java platform constitute a storage engine, which manages storing of said data into the memory and reading from the memory, which application reports via said interface to the storage engine the data to be stored, the application being associated with attributes required by its execution,
wherein a protection attribute is included among said attributes before loading the Java application, and said operating system has as its extension a protection program providing a protection service, and the method further comprises steps:
the storage engine finds out by means of a program component managing the attributes if there exists among them a protection attribute relating to the data reported by the application
the storage engine asks for the protection service, if the protection attribute exists, and
the protection program implements the protection of the data to be stored in connection with storing the data into the memory.

2. A method according to claim 1, the protection of the data to be stored being based on encryption utilizing a secret key.

3. A method according to claim 2, said key being calculated in a certain manner from program code of the Java application.

4. A method according to claim 2, a secret code permanently resident in the device being used as said key.

5. A method according to claim 2, said key being calculated using a password selected by a user as one operand.

6. A method according to claim 1, the protection of the data to be stored being based on inhibiting access to a memory range reserved for that data from all other programs than the Java application storing the data, for which inhibiting the protection program selects a secret code specific for the instant of storing.

7. A method according to claim 4, the inhibiting the access to said memory range from all other programs than the Java application that stores the data being implemented by means of a memory management software of the device.

8. A device equipped with software and memory, the software comprising a Java platform for executing Java applications, and an operating system, certain parts of which operating system and the Java platform constitute a storage engine, which is arranged to store into the memory and to read from the memory data used by the Java application loaded into the device, on the basis of control information transferred via a specified interface between the Java platform and the Java application, wherein
the operating system comprises as its extension a protection program for protecting the data stored in the memory by the Java applications,
the storage engine is arranged to find out if there is in information loaded to the device together with the Java application an attribute that requires protection of the data used by the application, and in a positive case to ask said protection program to protect the data to be stored into the memory, and
the protection program is arranged to implement the protection of said data in connection with storing it into the memory.

9. A device according to claim 8, the protection program comprising means to encrypt the data to be stored.

10. A device according to claim 8, the protection program comprising means to inhibit access to the memory range reserved for the data to be stored from all other programs than the Java application that stores the data.

11. A device according to claim 8, said protection program being included in the storage engine.

12. A device according to claim 8, being a mobile station.
